(19) United States
(12) Patent Application Publication
(10) Pub. No.: US 2021/0192392 A1
(43) Pub. Date: Jun. 24, 2021

(54) LEARNING METHOD, STORAGE MEDIUM STORING LEARNING PROGRAM, AND INFORMATION PROCESSING DEVICE

(71) Applicant: FUJITSU LIMITED, Kawasaki-shi (JP)

(72) Inventor: YUSUKE OKI, Kawasaki (JP)

(73) Assignee: FUJITSU LIMITED, Kawasaki-shi (JP)

(21) Appl. No.: 17/121,013

(22) Filed: Dec. 14, 2020

(30) Foreign Application Priority Data
Dec. 19, 2019 (JP) 2019-229399

(51) Int. Cl. G06N 20/00; G06N 5/00

(52) U.S. Cl. CPC G06N 20/00; G06N 5/003

(57) ABSTRACT

A learning method is executed by a computer. The method includes: obtaining a trained model in which training data having non-linear characteristics is learned by supervised learning using a first teacher label; classifying the training data by using the obtained trained model and calculating a score related to a factor of the obtainment of the classification result for the training data; clustering the training data based on the calculated score; applying a second teacher label based on clusters obtained from the clustering to the training data; and executing supervised learning of a decision tree by using the training data and the applied second teacher label.

### CROSS-REFERENCE TO RELATED APPLICATION

This application is based upon and claims the benefit of priority of the prior Japanese Patent Application No. 2019-229399, filed on Dec. 19, 2019, the entire contents of which are incorporated herein by reference.

### FIELD

The embodiments discussed herein are related to the learning technique.

### BACKGROUND

The classification using a trained model by the machine learning (or, simply “learning”) technique has been known to solve the problem in the classification of data having the non-linear characteristics. In the application to the fields of human resource and finance that desire the interpretation of which logic is used to obtain the classification result, there has been known an existing technique of classifying the data having the non-linear characteristics by using a decision tree, which is a model having high interpretability in the classification result.

Related techniques are disclosed in, for example, Japanese Laid-open Patent Publication Nos. 2010-9177 and 2016-109495.

### SUMMARY

According to an aspect of the embodiments, a learning method is executed by a computer. The method includes: obtaining a trained model in which learning data (or, training data) having non-linear characteristics is learned by supervised learning using a first teacher or teaching label; classifying the learning data by using the obtained trained model and calculating a score related to a factor of the obtainment of the classification result for the learning data; clustering the learning data based on the calculated score; applying a second teacher label based on clusters obtained from the clustering to the learning data; and executing supervised learning of a decision tree by using the learning data and the applied second teacher label.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram illustrating an example of a system configuration;

FIG. 2 is a flowchart illustrating operation examples of a host learning device and a client learning device;

FIG. 3 is an explanatory diagram describing a learning model of the supervised learning;

FIG. 4 is an explanatory diagram describing the data classification using the learning model;

FIG. 5 is a flowchart exemplifying clustering processing of learning data;

FIG. 6 is an explanatory diagram illustrating examples of a factor distance matrix and an error matrix;

FIG. 7A is an explanatory diagram describing the evaluation of the degree of influence on the error matrix;

FIG. 7B is an explanatory diagram describing the evaluation of the degree of influence on the error matrix;

FIG. 7C is an explanatory diagram describing the data deletion according to the degree of influence on the error matrix;

FIG. 8 is an explanatory diagram describing the clustering of the learning data;

FIG. 9 is an explanatory diagram describing the creation of new learning data;

FIG. 10 is an explanatory diagram describing the creation of a decision tree;

FIG. 11 is an explanatory diagram describing the comparison between the existing technique and the present embodiment;

FIG. 12 is an explanatory diagram describing the comparison between the existing technique and the present embodiment; and

FIG. 13 is a block diagram illustrating an example of a computer that executes a program.

### DESCRIPTION OF EMBODIMENTS

In the related art, the classification using the decision tree in the above-described existing technique has a problem that the classification accuracy is lower than that of using other models such as a gradient boosting tree (GBT) and a neural network, although the interpretability is higher.

In one aspect, an object is to provide a learning method, a storage medium storing a learning program, and an information processing device capable of creating a decision tree having an excellent classification accuracy.

Hereinafter, a learning method, a learning program, and an information processing device according to embodiments are described with reference to the drawings. In embodiments, the same reference numerals are used for a configuration having the same functions, and repetitive description is omitted. The learning method, the learning program, and the information processing device described in the embodiments described below are merely illustrative and not intended to limit the embodiment. The following embodiments may be combined as appropriate to the extent not inconsistent therewith.

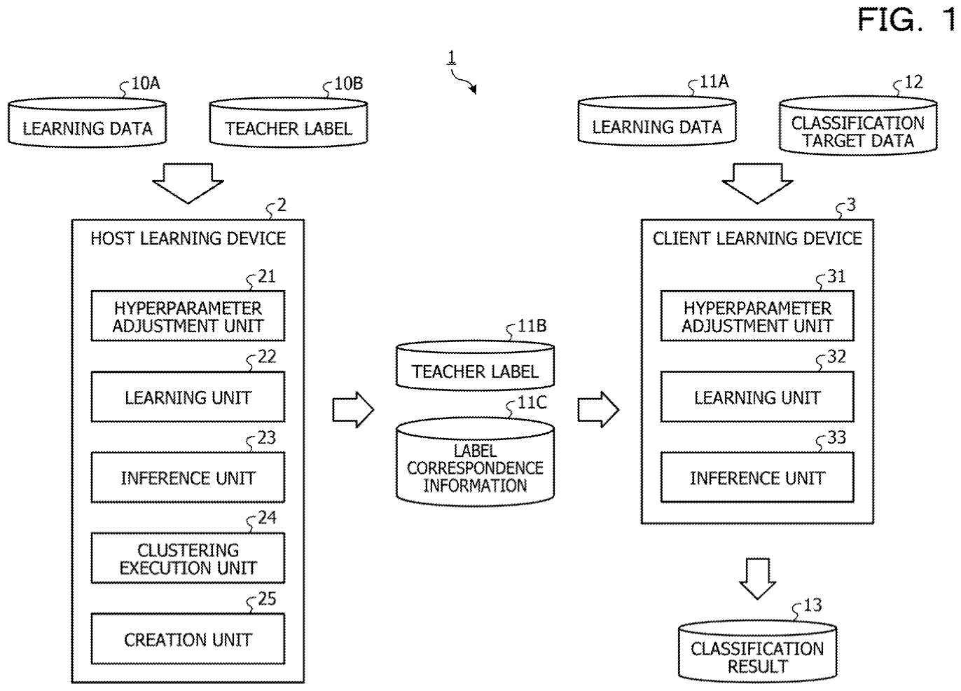

FIG. 1 is a block diagram illustrating an example of a system configuration. As illustrated in FIG. 1, an information processing system 1 includes a host learning device 2 and a client learning device 3. In the information processing system 1, the host learning device 2 and the client learning device 3 are used to perform the supervised learning with learning data 10A and 11A to which teacher or teaching labels 10B and 11B are applied. Then, in the information processing system 1, a model obtained by the supervised learning is used to classify classification target data 12, which is data having the non-linear characteristics, and obtain a classification result 13.

Although this embodiment exemplifies the system configuration in which the host learning device 2 and the client learning device 3 are separated from each other, the host learning device 2 and the client learning device 3 may be integrated as a single learning device. Specifically, the information processing system 1 may be formed as a single learning device and may be, for example, an information processing device in which a learning program is installed.

In this embodiment, here is exemplified for description a case where the pass or fail of an examination such as an entrance examination is classified based on the performance of an examinee that is an example of the data having the non-linear characteristics. For example, the information processing system 1 inputs the performances of Japanese, English, and so on of an examinee to the information processing system 1 as the classification target data 12 and obtains the pass or fail of the examination such as an entrance examination of the examinee as the classification result 13.

The learning data 10A and 11A are the performances of Japanese, English, and so on of examinees as samples. In this case, the learning data 11A and the classification target data 12 have the same data format. For example, when the learning data 11A is performance data (vector data) of English and Japanese of the sample examinees, the classification target data 12 is also the performance data (vector data) of English and Japanese of the subjects.

The data formats of the learning data 10A and the learning data 11A may be different from each other as long as the sample examinees are the same. For example, the learning data 10A may be image data of examination papers of English and Japanese of the sample examinees, and the learning data 11A may be the performance data (vector data) of English and Japanese of the sample examinees. In this embodiment, the learning data 10A and the learning data 11A are the completely same data. For example, the learning data 10A and 11A are both the performance data of English and Japanese of the sample examinees (examinee A, examinee B, examinee Z).

The host learning device 2 includes a hyperparameter adjustment unit 21, a learning unit 22, an inference unit 23, a clustering execution unit 24, and a creation unit 25.

The hyperparameter adjustment unit 21 is a processing unit that adjusts hyperparameters related to the machine learning such as the batch size, the number of iterations, and the number of epochs to inhibit the machine learning using the learning data 10A from being overlearning. For example, the hyperparameter adjustment unit 21 tunes the hyperparameters such as the batch size, the number of iterations, and the number of epochs by the cross-validation of the learning data 10A or the like.

The learning unit 22 is a processing unit that creates a learning model that performs the classification by the machine learning using the learning data 10A. Specifically, the learning unit 22 creates a learning model such as a gradient boosting tree (GBT) and a neural network by performing the publicly-known supervised learning based on the learning data 10A and the teacher labels 10B applied to the learning data 10A as correct answers (for example, the pass or fail of the sample examinees). For example, the learning unit 22 is an example of an obtainment unit.

The inference unit 23 is a processing unit that performs the inference (the classification) using the learning model created by the learning unit 22. For example, the inference unit 23 classifies the learning data 10A by using the learning model created by the learning unit 22. For example, the inference unit 23 inputs the performance data of the sample examinees in the learning data 10A into the learning model created by the learning unit 22 to obtain the probability of the pass or fail of each examinee as a classification score. Then, based on the classification scores thus obtained, the inference unit 23 classifies the pass or fail of the sample examinees.

The inference unit 23 calculates a score (hereinafter, a factor score) of a factor of the obtainment of the classification result for the learning data 10A. For example, the inference unit 23 calculates the factor score by using publicly-known techniques such as the local interpretable model-agnostic explanations (LIME) and the Shapley additive explanations (SNAP) which interpret that on what basis the classification by the machine learning model is performed. For example, the inference unit 23 is an example of a calculation unit.

The clustering execution unit 24 is a processing unit that clusters the learning data 10A by using the factor score calculated by the inference unit 23. For example, the clustering execution unit 24 gathers the learning data 10A having similar factors according to the factor score calculated by the inference unit 23 and divides the learning data 10A into multiple clusters.

The creation unit 25 is a processing unit that changes the teacher labels 10B applied to the learning data 10A as correct answers to the teacher labels 11B based on the clusters obtained by the clustering by the clustering execution unit 24. For example, the creation unit 25 creates the teacher labels 11B by changing the teacher labels 10B, which indicate correct answers (the pass or fail) applied to the respective sample examinees of the learning data 10A, to labels indicating in which cluster out of the multiple clusters divided by the clustering execution unit 24 the data is included. The creation unit 25 creates label correspondence information 11C that indicates a correspondence relationship before and after the change from the teacher labels 108 to the teacher labels 118.

The client learning device 3 includes a hyperparameter adjustment unit 31, a learning unit 32, and an inference unit 33.

The hyperparameter adjustment unit 31 is a processing unit that adjusts hyperparameters related to the machine learning such as the batch size, the number of iterations, and the number of epochs to inhibit the machine learning using the learning data HA from being overlearning. For example, the hyperparameter adjustment unit 21 tunes the hyperparameters such as the batch size, the number of iterations, and the number of epochs by the cross-validation of the learning data 11A or the like.

The learning unit 32 is a processing unit that performs the publicly-known supervised learning related to a decision tree by using the learning data 11A and the teacher labels 118 changed from the teacher labels 108. Specifically, the decision tree learned by the learning unit 32 includes multiple nodes and edges coupling the nodes, and intermediate nodes are associated with branch conditions (for example, conditional expressions of a predetermined data item). Terminal nodes in the decision tree are associated with labels of the teacher labels 11B or specifically the clusters obtained by the clustering by the clustering execution unit 24.

Through the publicly-known supervised learning related to the decision tree, the learning unit 32 creates the decision tree by determining the branch conditions for the intermediate nodes so as to reach the terminal nodes associated with the labels applied to the teacher labels 11B for the corresponding sample examinees of the learning data 11A.

The learning unit 32 performs the replacement of the terminal nodes in the learned decision tree based on the label correspondence information 11C indicating the correspondence relationship in the change from the teacher labels 10B to the teacher labels 1113. Specifically, the learning unit 32 replaces the terminal nodes associated with the labels of the teacher labels 11B in the learned decision tree with the labels of the teacher labels 10B (for example, the pass or fail of the examinees) according to the correspondence relationship indicated by the label correspondence information 11C. Thus, with the classification using the learned decision tree, it is possible to obtain the classification result (for example, the pass or fail of the examinees) corresponding to the teacher labels 10B by reaching the terminal nodes according to the branch conditions for the intermediate nodes.

The inference unit 33 is a processing unit that performs the inference (the classification) of the classification target data 12 using the decision tree learned by the learning unit 32. For example, the inference unit 33 obtains the classification result 13 by following the edges of the conditions corresponding to the classification target data 12 out of the branch conditions for the intermediate nodes in the decision tree learned by the learning unit 32 until reaching the terminal nodes.

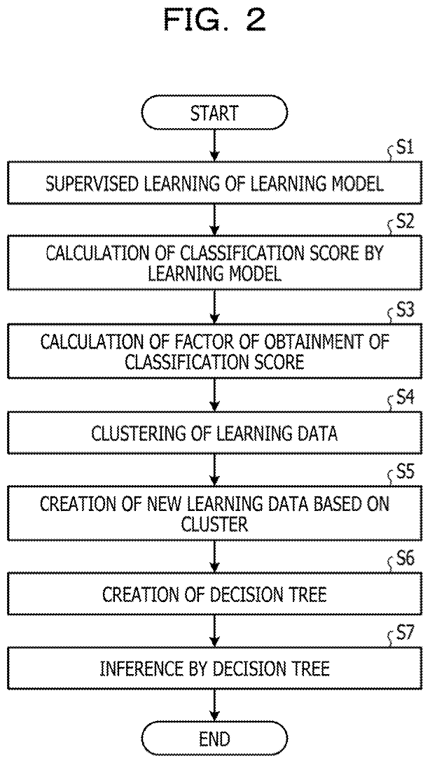

FIG. 2 is a flowchart illustrating operation examples of the host learning device 2 and the client learning device 3. As illustrated in FIG. 2, once the processing is started, the learning unit 22 performs the supervised learning of the learning model by using the learning data 10A and the teacher labels 10B applied to the learning data 10A as correct answers (S1).

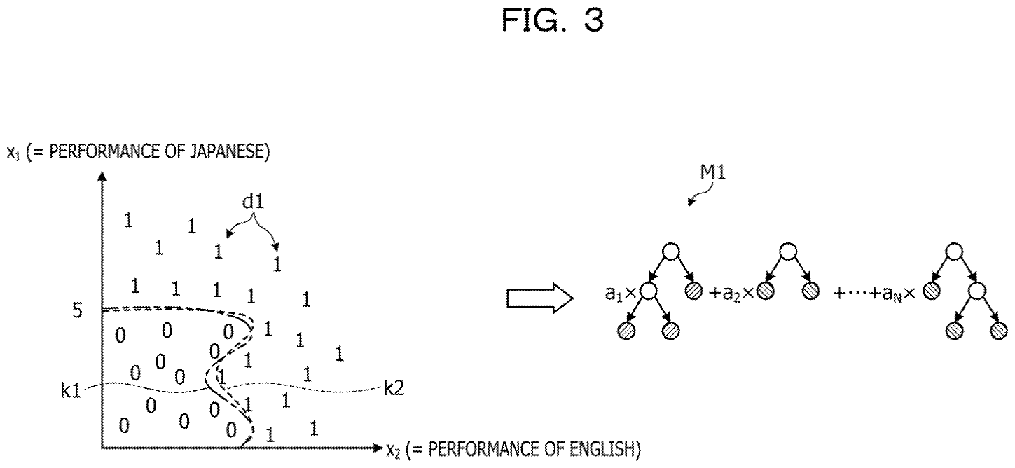

FIG. 3 is an explanatory diagram describing a learning r model of the supervised learning. The left side of FIG. 3 illustrates distributions in a plane of a performance (x₁) of Japanese and a performance (x₂) of English for data d1 of the sample examinees included in the learning data 10A. “1” or “0” in the data dl indicates a label of the pass or fail applied as the teacher label 108, while “1” indicates an examinee who passes, and “0” indicates an examinee who fails.

The learning unit 22 obtains a learning model M1 by adjusting weights (a₁, a₂, . . . a_{N}) in the learning model M1 so as to make a boundary k1 closer to a true boundary k2 in the learning model M1 of a gradient boosting tree (GBT) that classifies the examinees into who passes and who fails, as illustrated in FIG. 3.

Referring back to FIG. 2 and following S1, the inference unit 23 classifies the learning data 10A by using the learning model M1 created by the learning unit 22 and calculates the classification score of each of the sample examinees included in the learning data 10A (S2).

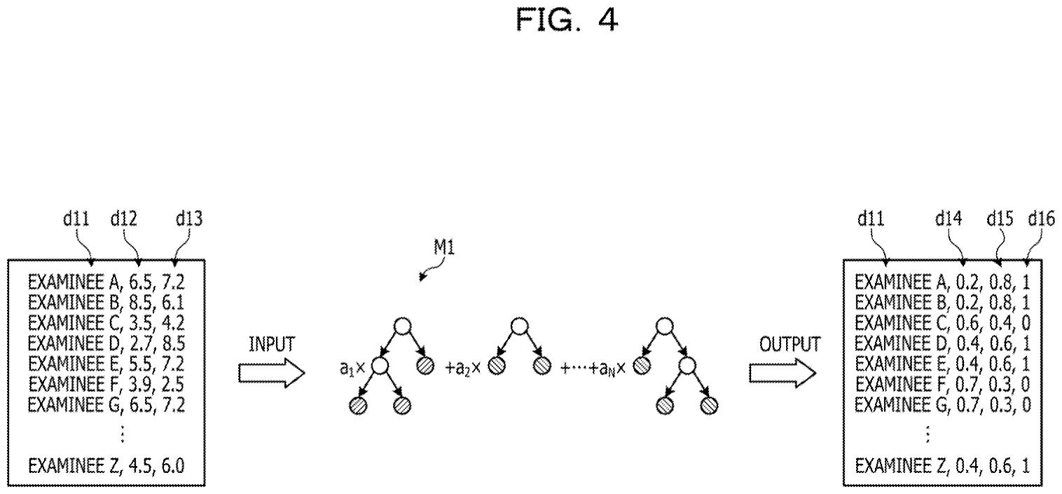

FIG. 4 is an explanatory diagram describing the data classification using the learning model M1. As illustrated in FIG. 4, the learning unit 22 inputs performances (Japanese) d12 and performances (English) d13 of corresponding examinees d11, which are the “examinee A”, the “examinee B”, . . ., the “examinee Z”, into the learning model M1 to obtain outputs of fail rates d14 and pass rates d15 related to the classification of the pass or fail of the examinees d11. The learning unit 22 determines classification results d16 based on the obtained fail rates d14 and pass rates d15. For example, the learning unit 22 sets “1” indicating the pass as the classification result d16 when the pass rate d15 is greater than the fail rate d14 and sets “0” indicating the fail as the classification result d16 when the pass rate d15 is not greater than the fail rate d14.

Referring back to FIG. 2, the inference unit 23 uses the publicly-known techniques such as the LIME and the SHAP that investigate the factor of the classification performed by the learning model M1 to calculate the factor of the obtainment of the classification score (the factor score) (S3).

For example, since the performance of the “examinee A” is (the performance of English, the performance of Japanese)=(6.5, 7.2), the “examinee A” is classified to the pass “1” with the performance being inputted in the learning model M1. With the publicly-known techniques such as the LIME and the SHAP, the inference unit 23 obtains the degrees of contribution of the performance of English and the performance of Japanese to the pass of the “examinee A” as the factor score indicating the factor of the classification. For example, the inference unit 23 obtains (the performance of English, the performance of Japanese)=(3.5, 4.5) as the degrees of contribution of the performance of English and the performance of Japanese to the pass of the “examinee A” as the factor score of the pass of the “examinee A”. Based on this factor score, it is possible to see that the performance of Japanese more contributes than the performance of English to the pass of the “examinee A”.

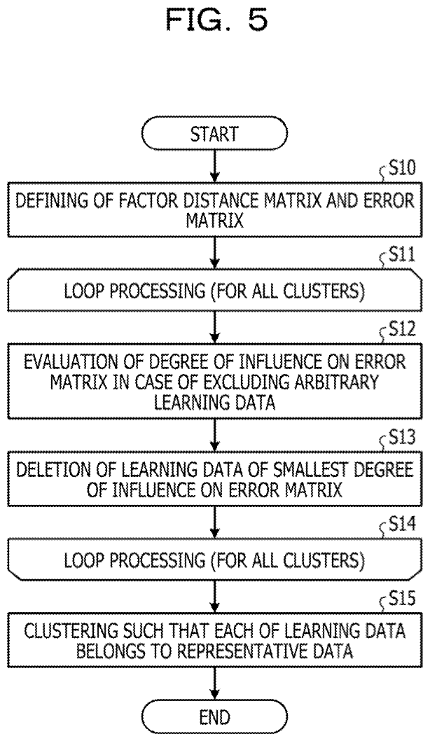

Then, the clustering execution unit 24 uses the factor score calculated by the inference unit 23 to execute the clustering of the learning data 10A (S4). FIG. 5 is a flowchart exemplifying the clustering processing of the learning data 10A.

As illustrated in FIG. 5, once the clustering processing is started, the clustering execution unit 24 defines a factor distance matrix and an error matrix (S10).

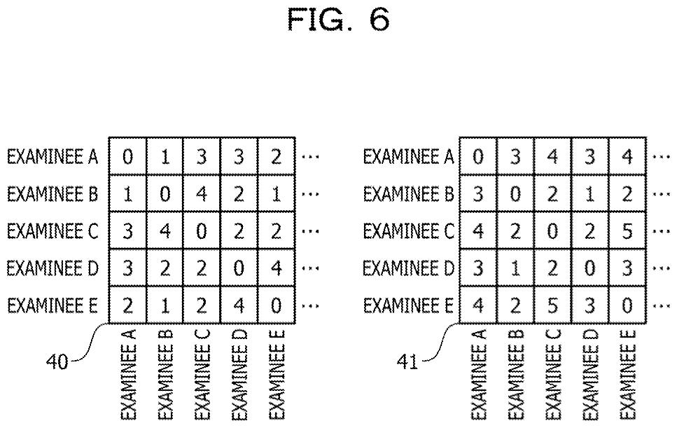

FIG. 6 is an explanatory diagram illustrating examples of the factor distance matrix and the error matrix, As illustrated in FIG. 6, a factor distance matrix 40 is a matrix in which a distance (a factor distance) between the factor scores of one examinee as oneself and the other examinee out of the sample examinees (“examinee A”, “examinee B”. . .) in the learning data 10A is arrayed. Specifically, the factor distance matrix 40 is a symmetric matrix in which the factor distance between the one examinee and oneself is “0”. In the factor distance matrix 40 in FIG. 6, the factor distance between the “examinee D” and the “examinee E” is “4”. The clustering execution unit 24 defines the factor distance matrix 40 by, for example, obtaining a distance between the vector data of oneself and the other examinee based on the vector data of the degrees of contribution of the performances of English and Japanese for each of the sample examinees.

An error matrix 41 is a matrix in which an error (for example, a distance between the classification scores of oneself and the other examinee) that occurs when the classification is performed with the classification score of the other examinee for each of the sample examinees (the “examinee A”, the “examinee B”. . .) in the learning data 10A is arrayed. Specifically, the error matrix 41 is a symmetric matrix in which the error between the one examinee and oneself is “0”. In the error matrix 41 in FIG. 6, the error that occurs when the classification of the “examinee A” is performed with the classification score of the “examinee C” is “4”. The clustering execution unit 24 defines the error matrix 41 by, for example, obtaining the error based on the classification scores for each of the sample examinees,

Referring back to FIG. 5 and following S10, the clustering execution unit 24 repeats loop processing until the number of the data (the representative data) as the representative of the dusters that remain without being deleted from the defined factor distance matrix 40 and error matrix 41 matches the number set in advance by a user or the like (S11 to S14). For example, the clustering execution unit 24 repeats the processing of S12 and S13 until the representative data of the number corresponding to the predetermined number of the clusters remain without being deleted from the factor distance matrix 40 and the error matrix 41.

For example, once the loop processing is started, the clustering execution unit 24 evaluates the degree of influence on the error matrix 41 in the case of deleting arbitrary learning data from the factor distance matrix 40 (S12).

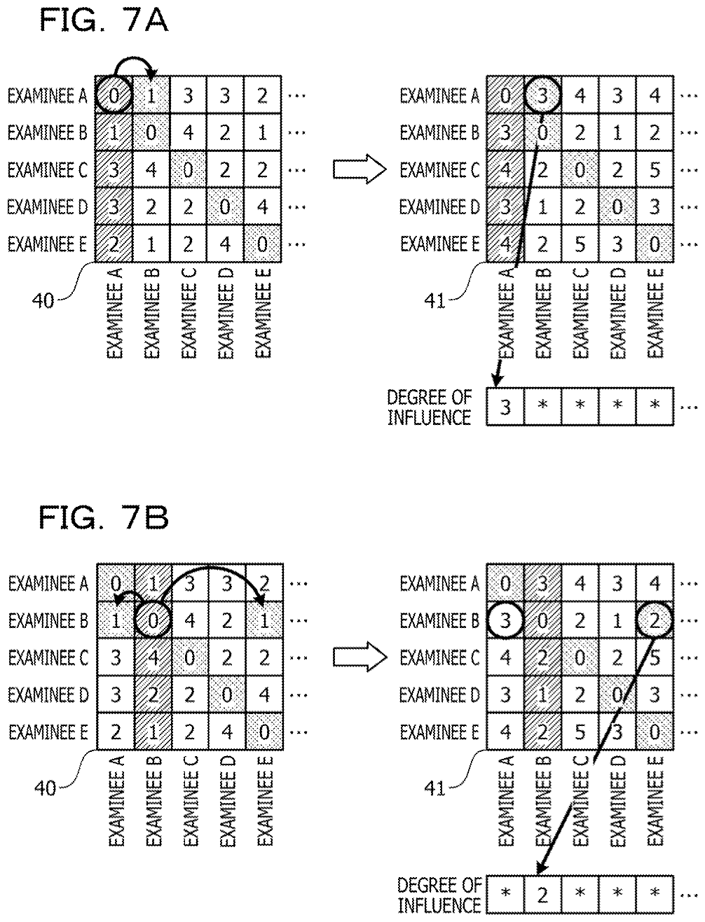

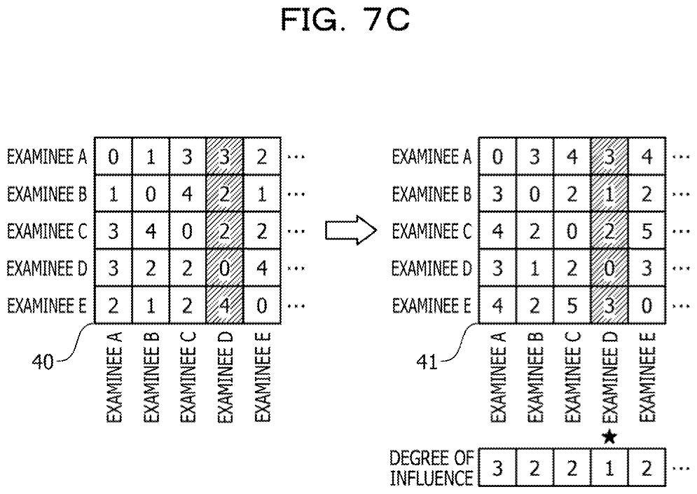

FIG. 7A and FIG. 7B are explanatory diagrams describing the evaluation of the degree of influence on the error matrix 41. As illustrated in FIG. 7A, here is assumed a case of excluding the “examinee A” from the factor distance matrix 40, for example. Based on the factor distances to the “examinee A” in the factor distance matrix 40, an examinee who has the factor closest to that of the “examinee A” is the “examinee B” with the factor distance of “1”. In this way, the clustering execution unit 24 identifies data of the factor close to that of the data as the target of the deletion from the factor distance matrix 40.

Then, the clustering execution unit 24 refers to the error matrix 41 and evaluates the error (the degree of influence) of a case of performing the classification with a classification score of the closest factor (the classification score of the other examinee). For example, since the “examinee B” is the person who has the factor closest to that of the “examinee A”, it is possible to see that, when the “examinee A” is excluded from the factor distance matrix 40 and the classification score of the “examinee B” is used, the error (the degree of influence) is increased by “3” based on the error matrix 41.

As illustrated in FIG. 7B, here is assumed a case of excluding the “examinee B” from the factor distance matrix 40, for example. Based on the factor distances to the “examinee B” in the factor distance matrix 40, examinees who have the factor closest to that of the “examinee B” are the “examinee A” and the “examinee E” with the factor distance of “1”. In this way, the clustering execution unit 24 identifies data of the factor close to that of the data as the target of the deletion from the factor distance matrix 40.

Then, the clustering execution unit 24 refers to the error matrix 41 and evaluates the error (the degree of influence) of a case of performing the classification with a classification score of the closest factor (the classification score of the other examinee). For example, since the “examinee A” and the “examinee E” are the people who have the factor closest to that of the “examinee B”, it is possible to see that, when the “examinee B” is excluded from the factor distance matrix 40 and the classification scores of the “examinee A” and the “examinee E” are used, the error (the degree of influence) is increased by at least “2” based on the error matrix 41.

Referring back to FIG. 5 and following S12, based on the degree of influence evaluated in S12, the clustering execution unit 24 deletes the learning data of the smallest degree of influence on the error matrix 41 from the factor distance matrix 40 and the error matrix 41 (S13).

FIG. 7C is an explanatory diagram describing the data deletion according to the degree of influence on the error matrix 41. As illustrated in FIG. 7C, the clustering execution unit 24 deletes the “examinee D” who has the smallest degree of influence “1” from the factor distance matrix 40 and the error matrix 41. Consequently, the remains in the factor distance matrix 40 and the error matrix 41 are four people, the “examinee A”, the “examinee B”, the “examinee C”, and the “examinee E”. As described above, the clustering execution unit 24 repeats the loop processing until the number of the remains reaches the number of the clusters.

Referring back to FIG. 5 and following the loop processing (S11 to S14), the clustering execution unit 24 executes the clustering such that each of the learning data (the data dl of the sample examinees) of the learning data 10A belongs to a cluster represented by the representative data of the shortest distance (S15).

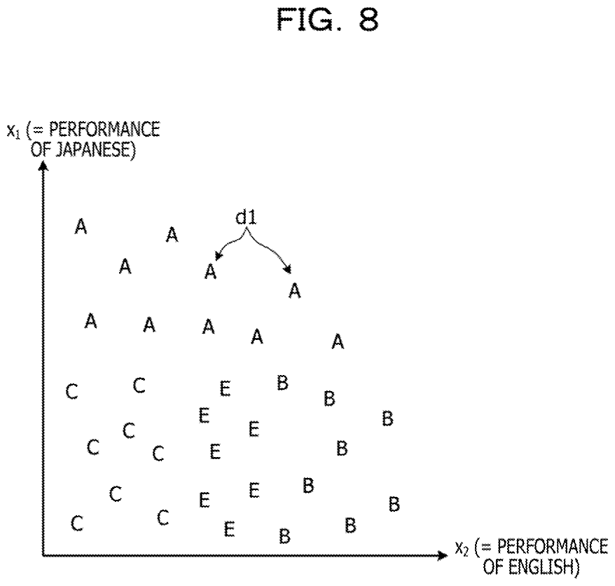

FIG. 8 is an explanatory diagram describing the clustering of the learning data. In the loop processing (S11 to S14), the data dl of the four people, the “examinee A”, the “examinee B”, the “examinee C”, and the “examinee E”, remain as the representative data. As illustrated in FIG. 8, the clustering execution unit 24 clusters the data dl included in the learning data 10A based on the factor distances such that each of the data dl belongs to a cluster represented by the representative data of the shortest distance. Consequently, each of the data dl included in the learning data 10A belongs to any one of the clusters “A”, “B”, “C”, and “E”.

Referring back to FIG. 2 and following S4, the creation unit 25 creates new learning data in which the teacher labels 106 applied as correct answers to the learning data 10A are changed to the teacher labels 116, based on the clusters obtained by the clustering execution unit 24 (S5).

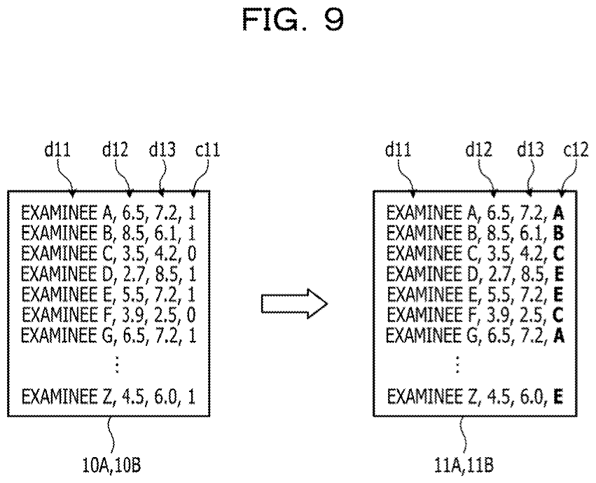

FIG. 9 is an explanatory diagram describing the creation of the new learning data. As illustrated in FIG. 9, in the original learning data (combinations of the learning data 10A and the teacher labels 106), teacher labels c11 indicating the pass or fail of the examination (pass=“1”/fail=“0”) are applied with the performances (Japanese) d12 and the performances (English) d13 for the examinees d11.

The creation unit 25 changes the teacher labels 106 to the teacher labels 116 based on the clusters obtained from the clustering by the clustering execution unit 24. Consequently, in the new learning data (combinations of the learning data 11A and the teacher labels 11B), teacher labels c12 indicating the clusters to which the examinees d11 belong (for example, “A”, “B”, “C”, and “D”) are applied with the performances (Japanese) d12 and the performances (English) d13 for the examinees d11.

Referring back to FIG. 2 and following S5, the learning unit 32 performs the publicly-known supervised learning by using the learning data 11A and the teacher labels 11B changed from the teacher labels 10B, or using the new learning data, to create the decision tree (S6).

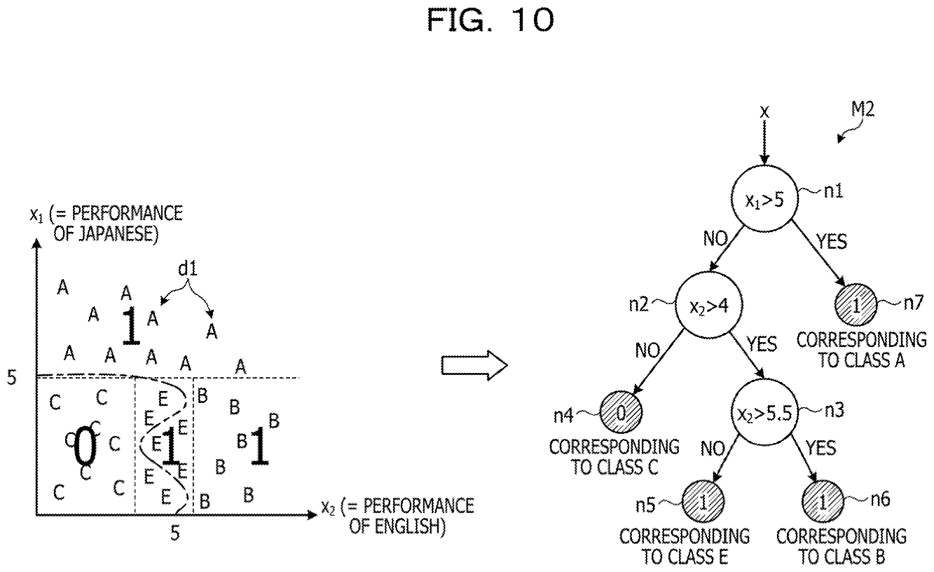

FIG. 10 is an explanatory diagram describing the creation of the decision tree. As illustrated in FIG. 10, the learning unit 32 creates a decision tree M2 by determining the branch conditions for intermediate nodes (n1 to n3) so as to reach terminal nodes (n4 to n7) associated with the labels (for example, “A”, “B”, “C”, and “D”) applied to the teacher labels 11B.

Then, after the learning of the decision tree M2 is completed, the learning unit 32 restores the labels of the terminal nodes (n4 to n7) (for example, “A”, “B”, “C”, and “D”) to the state before the conversion (for example, pass=“1”/fail=“0”). For example, the learning unit 32 performs the replacement of the terminal nodes (n4 to n7) in the learned decision tree M2 based on the label correspondence information 11C indicating the correspondence relationship in the change from the teacher labels 10B to the teacher labels 11B.

Referring back to FIG. 2 and following 56, the inference unit 33 makes the inference on the classification target data 12 by using the decision tree M2 learned by the learning unit 32 and obtains the classification result 13 (S7).

As described above, the information processing system 1 obtains the learning model M1 by learning the learning data 10A having the non-linear characteristics by the supervised learning using the teacher labels 106. The information processing system 1 classifies the learning data 10A by using the obtained learning model M1 and calculates the scores related to the factors of the obtainment of the classification result for the learning data 10A. The information processing system 1 clusters the learning data 10A by using the calculated scores. The information processing system 1 applies the teacher labels 11B based on the clusters obtained from the clustering to the learning data 10A (11A). The information processing system 1 performs the supervised learning of the decision tree M2 by using the learning data 11A and the applied teacher labels 11B.

Thus, according to the information processing system 1, since the teacher labels used for the learning of the decision tree M2 are changed based on the clusters in which the learning data having the factors are gathered based on the scores related to the factors of the obtainment of the classification result, it is possible to improve the classification accuracy of the decision tree M2. Therefore, in the classification of the classification target data 12, it is possible to obtain accurate classification result 13 while maintaining the high interpretability of the decision tree M2.

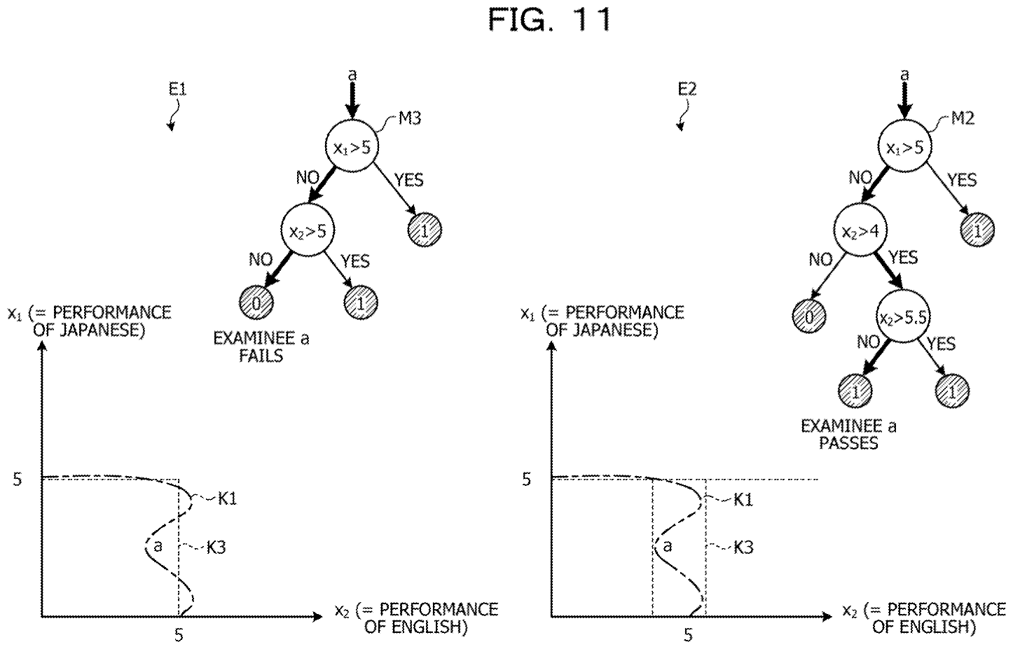

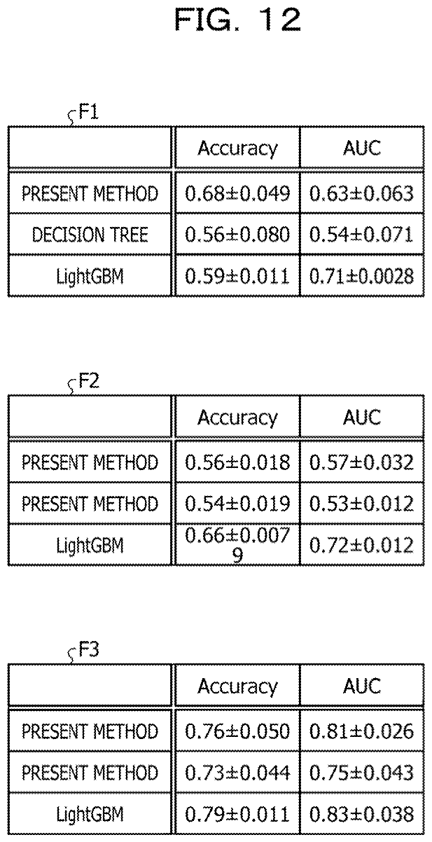

FIG. 11 and FIG. 12 are explanatory diagrams describing the comparison between the existing technique and the present embodiment. In FIG. 11, the classification in a case El is performed by using a decision tree M3 created by applying the existing technique, and the classification in a case E2 is performed by using the decision tree M2 created in this embodiment. The classification target data 12 in the cases E1 and E2 are the same and are, for example, the performances (Japanese (x₁), English (x₂)) of an “examinee a”.

As illustrated in FIG. 11, comparing with a true boundary K1 dividing the pass or fail of the examinees, the pass or fail of the “examinee a” is inverted in the case E1 in which a boundary K3 divides the pass or fail according to the decision tree M3. Consequently, although the “examinee a” is actually classified as the pass, the “examinee a” is classified as the fail in the classification using the decision tree M3. On the contrary, in the case E2 in which the boundary K3 divides the pass and fail according to the decision tree M2, the pass or fail of the “examinee a” matches (see “1” in “E” on the right side in FIG. 10). Thus, in the classification using the decision tree M2, it is possible to perform the correct classification matching the actual pass or fail. In the classification using the decision tree M2, it is possible to maintain the high interpretability of the pass or fail based on the branch conditions for the intermediate nodes.

FIG. 12 exemplifies Experimental Examples F1 to F3 in which the free datasets of kaggle are used to obtain Accuracy, or area under the curve (AUC), which is an evaluation value of the machine learning. For example, evaluation values of a method according to this embodiment (present method), a method using only a decision tree (decision tree), and a method using only the LightGBM that is a kind of GBTs (LightGBM) are obtained and compared with each other for the free datasets.

Experimental Example F1 is an experimental example using a free dataset of a binary classification problem designed to implement overlearning (www.kaggle.com/c/dont-overfit-ii/overview). Experimental Example F2 is an experimental example using a free dataset of a binary classification problem related to the transaction prediction (www.kaggle.com/lakshmi25npathi/santander-customer-transaction-prediction-dataset). Experimental Example F3 is an experimental example using a free dataset of a binary classification problem related to a heart disease (www.kaggle.com/ronitf/heart-disease-uci). In Experimental Examples F1 to F3, the evaluation values are obtained based on an average value of ten trials of the learning and the inference.

As illustrated in FIG. 12, in any of Experimental Examples F1 to F3 with the present method, although some cases fall short of the LightGBM that is capable of making closer to the true boundary, it is possible to obtain the classification result with a higher accuracy than that using the decision tree.

The information processing system 1 obtains the representative data representing the clusters by deleting the learning data of a small degree of influence on the error from the learning data 10A, based on the errors of the learning data 10A in the case of the classification using the learning data having dose scores of the factors in the clustering. Then, the information processing system 1 dusters the learning data such that the learning data belongs to any one of the dusters represented by the representative data based on the scores. Thus, according to the information processing system 1, it is possible to cluster the learning data having similar factors based on the representative data representing the clusters.

The information processing system 1 replaces the nodes associated with the teacher labels 11B for the learned decision tree M2 with the nodes associated with the teacher labels 106 based on the correspondence relationship in the change from the teacher labels 106 to the teacher labels 116. Thus, according to the information processing system 1, it is possible to obtain the classification result 13 corresponding to the original teacher labels 106 (for example, the pass or fail of the examination) for the classification target data 12.

The components of parts illustrated in the drawings are not necessarily configured physically as illustrated in the drawings. For example, specific forms of dispersion and integration of the parts are not limited to those illustrated in the drawings, and all or part thereof may be configured by being functionally or physically dispersed or integrated in given units according to various loads, the state of use, and the like. For example, the hyperparameter adjustment unit 21 and the learning unit 22, the clustering execution unit 24 and the creation unit 25, or the hyperparameter adjustment unit 31 and the learning unit 32 may be integrated with each other. The order of processing illustrated in the drawings is not limited to the order described above, and the processing may be simultaneously performed or the order may be switched within the range in which the processing contents do not contradict one another.

All or any of the various processing functions performed in the devices may be performed on a central processing unit (CPU) (or a microcomputer, such as a microprocessor unit (MPU) or a microcontroller unit (MCU)). It is to be understood that all or any part of the various processing functions may be executed on programs analyzed and executed by the CPU (or the microcomputer such as the MPU or the MCU) or on hardware using wired logic. The various processing functions may be enabled by cloud computing in which a plurality of computers cooperate with each other.

The various processing described above in the embodiments may be enabled by causing a computer to execute a program prepared in advance.

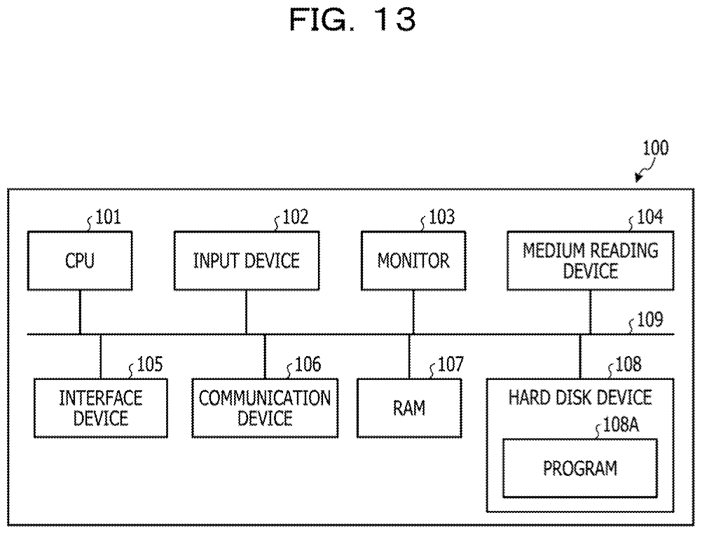

An example of a computer configured to execute a program having the same functions as those of the above-discussed embodiments will be described below. FIG. 13 is a block diagram illustrating an example of the computer that executes the program.

As illustrated in FIG. 13, a computer 100 includes a CPU 101 configured to execute various arithmetic processing, an input device 102 configured to receive data input, and a monitor 103. The computer 100 includes a medium reading device 104 configured to read a program and the like from a storage medium, an interface device 105 to be coupled with various devices, and a communication device 106 to be coupled to another information processing device or the like by wired or wireless communication. The computer 100 also includes a RAM 107 configured to temporarily store various information, and a hard disk device 108. The devices 101 to 108 are coupled to a bus 109.

The hard disk device 108 stores a program 108A having the functions similar to those of the processing units (for example, the hyperparameter adjustment units 21 and 31, the learning units 22 and 32, the inference units 23 and 33, the clustering execution unit 24 and the creation unit 25) in the information processing system 1 illustrated in FIG. 1. The hard disk device 108 stores various data for implementing the processing units in the information processing system 1. The input device 102 receives input of various kinds of information, such as operation information, from a user of the computer 100, for example. The monitor 103 displays various kinds of screens, such as a display screen, for the user of the computer 100, for example. To the interface device 105, for example, a printing device is coupled. The communication device 106 is coupled to a network (not illustrated) and transmits and receives various kinds of information to and from another information processing device.

The CPU 101 executes various processing by reading out the program 108A stored in the hard disk device 108, loading the program 108A on the RAM 107, and executing the program 108A. These processes may function as the processing units (for example, the hyperparameter adjustment units 21 and 31, the learning units 22 and 32, the inference units 23 and 33, the clustering execution unit 24 and the creation unit 25) in the information processing system 1 illustrated in FIG. 1.

The above-described program 108A may not be stored in the hard disk device 108. For example, the computer 100 may read and execute the programs 108A stored on a storage medium readable by the computer 100. The recording medium readable by the computer 100 corresponds to, for example, a portable storage medium, such as a compact disc read-only memory (CD-ROM), a digital versatile disc (DVD), or a Universal Serial Bus (USB) memory, a semiconductor memory, such as a flash memory, or a hard disk drive, The programs 108A may be stored in a device coupled to a public network, the Internet, a LAN, or the like, and the computer 100 may read and execute the programs 108A from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A computer-implemented machine learning method comprising:
obtaining a machine learning model which has learned training data having non-linear characteristics by supervised learning;
classifying the training data by using the obtained machine learning model and calculating a score related to a factor of a classification result of the classifying;
clustering the training data based on the calculated score;
labeling the training data with a first label based on a cluster generated by the clustering; and
executing supervised learning of a decision tree by using the labeled training data.

2. The learning method according to claim 1, wherein the clustering includes:
deleting training data of smallest degree of influence on an error from the training data based on errors of the training data in a case of a classification using the training data having closer scores to determine representative data representing the clusters; and
clustering the training data based on the scores and the representative data.

3. The learning method according to claim 1, wherein
the labeling includes changing a second label of the training data, used when the machine learning model has learned the training data, to the first label; and
the executing the supervised learning of the decision tree includes replacing a node associated with the first label included in the learned decision tree with a node associated with the second label based on a correspondence relationship in the changing from the second label to the first label.

4. A non-transitory computer-readable storage medium having stored a learning program causing a computer to execute a process comprising:
obtaining a machine learning model which has learned training data having non-linear characteristics by supervised learning;
classifying the training data by using the obtained machine learning model and calculating a score related to a factor of a classification result of the classifying;
clustering the training data based on the calculated score;
labeling the training data with a first label based on a cluster generated by the clustering; and
executing supervised learning of a decision tree by using the labeled training data.

5. The storage medium according to claim 4, wherein the clustering includes:
deleting training data of smallest degree of influence on an error from the training data based on errors of the training data in a case of a classification using the training data having closer scores to determine representative data representing the clusters; and
clustering the training data based on the scores and the representative data.

6. The storage medium according to claim 4, wherein
the labeling includes changing a second label of the training data, used when the machine learning model has learned the training data, to the first label; and
the executing the supervised learning of the decision tree includes replacing a node associated with the first label included in the learned decision tree with a node associated with the second label based on a correspondence relationship in the changing from the second label to the first label.

7. An information processing device comprising:
a memory, and
a processor coupled to the memory and configured to:
obtain a machine learning model which has learned training data having non-linear characteristics by supervised learning;
classify the training data by using the obtained machine learning model and calculate a score related to a factor of a classification result of the classifying;
cluster the training data based on the calculated score;
label the training data with a first label based on a cluster generated; and
execute supervised learning of a decision tree by using the labeled training data.

8. The information processing device according to claim 7, wherein the processor is configured to cluster the training data by at least,
deleting training data of smallest degree of influence on an error from the training data based on errors of the training data in a case of a classification using the training data having closer scores to determine representative data representing the clusters; and
clustering the training data based on the scores and the representative data.

9. The information processing device according to claim 7, wherein
the processor is configured to label the training data with the first label by changing a second label of the training data, used when the machine learning model has learned the training data, to the first label; and
the processor is configured to execute the supervised learning of the decision tree by replacing a node associated with the first label included in the learned decision tree with a node associated with the second label based on a correspondence relationship in the changing from the second label to the first label.
